(19) United States
(12) Patent Application Publication
(10) Pub. No.: US 2009/0228662 A1
(43) Pub. Date: Sep. 10, 2009

(54) MULTI-CHANNEL MEMORY STORAGE DEVICE AND CONTROL METHOD THEREOF

(75) Inventors: Hui-Neng Chang, Bade City (TW); Chuan-Sheng Lin, Jhubei City (TW)

Correspondence Address: RABIN & Berdo, PC, 1101 14TH STREET, NW, SUITE 500, WASHINGTON, DC, 20005, US

(73) Assignee: A-DATA TECHNOLOGY CO., LTD., Taipei (TW)

(21) Appl. No.: 12/203,226

(22) Filed: Sep. 3, 2008

(30) Foreign Application Priority Data
Mar. 7, 2008 (TW) 97108008

(51) Int. Cl. G06F 12/10

(52) U.S. Cl. 711/148; 711/E12.066

(57) ABSTRACT

The present invention discloses a multi-channel memory storage device and control method thereof. The method arranges physical locations for a file's data stored in the storage device. The storage device includes a plurality of memories. The major feature of the method is to decide whether the data is written to a single memory or parallel memories according to the size of the data.

### BACKGROUND OF THE INVENTION

1. Field of the Invention

The present invention relates to a storage device, particularly to a multi-channel memory storage device and control method thereof.

2. Description of Related Art

It is time-consuming to write data into a storage device. In the prior art, a plurality of memories are set in the storage device to increase access rate, and the plurality of memories are connected in parallel to synchronously access the data in the memories, thereby increasing the rate of data transmission and data access.

Please refer to FIG. 1, which is a system block diagram illustrating a multi-channel memory storage device of the prior art. Therein, two parallel memories are taken as an example to illustrate how a double-channel memory storage device accesses data. A multi-channel memory storage device 20 is used in a digital system 1 to access data. In the digital system 1, the storage device 20 is coupled to a host 10 and receives instructions from the host 10.

The multi-channel memory storage device 20 includes a control unit201 and a nonvolatile memory unit 70. The control unit 201 is coupled between the host 10 and the nonvolatile memory unit 70. The control unit201 receives an instruction from the host 10 in order to save the data corresponding to the logic block address, which corresponds to the instruction, into nonvolatile memory unit 70. In further detail, the nonvolatile memory unit 70 includes a first memory unit 203 and a second memory unit 205, which are coupled to the control unit 201 via data transmitting wires 207 and 209 respectively for data transmission, and also collectively coupled to the control unit 201 via a instruction transmitting wire 211 for data transmission.

Please also refer to FIG. 2, which is an action schematic view and illustrates how data is written into a multi-channel memory storage device of FIG. 1. A plurality of blocks are partitioned in the first memory unit 203 and the second memory unit 205, and B0, B2 represent any two random blocks that are part of unit 203 and unit 205. Each block B0, B2 is further partitioned into N number of pages, wherein the N number of pages can record data of set size, which shall be referred to as P1, P2, . . . , and Pn. When data received by the control unit 201 reaches the 1 page set size, the control unit 201 will equally divides the data (let the data be called “first incoming data set” for clarification purpose) into two parts (if there are M parallel memories, the first incoming data set is divided into M parts, since in this prior art example we have 2 memory units of 203 and 205, the data is divided into 2). The two parts of the divided data are respectively written into page P1 of block B2 of the first memory unit 203 and page P1 of block B2 of the second memory unit 205. Later, if more data are received that needs recording, the control unit 201 will equally divides the later data (let the later data be called “second incoming data set”) into two parts according to the previous mentioned size condition, and arranges the second incoming data set into the blocks B0 of the two memory units, wherein, the second incoming data set is not updated data from the first incoming data set but only contains other new data. Now, if the second incoming data set includes updated data from the first incoming data set, then some extra process needs to be done; specifically all the data in block B2-P1 of unit 203 and unit 205, which contains first data set and possibly other data set, would need to be copied along with second incoming data set into blocks B0 of unit 203 and unit 205, and then data in block B2-P1 of unit 203 and unit 205 to clear up space for future incoming data.

Thus, in the prior art, although the data is written via two channels and synchronously registered in two memory units, so that the writing time is reduced by half, but when compared with a single memory unit that is accessing same data (i.e. first incoming data set and updated incoming data set), there would be additional processes of data copying and block erasing. The affect of these additional process would be even more apparent when the saved file size is small and when there are numerous parallel memory units, because that would result in additional write/delete process to the memory, thereby reducing the life-span of the storage device.

Consequently, because of the technical defects described above, the applicant strives via experience and research to develop the present invention, which can effectively improve the defects described above.

### SUMMARY OF THE INVENTION

The present invention assesses the characteristic of the incoming data by identifying the size of the data, thereby adjusting channel mode (using single channel or multi-channel) to store and transmit the incoming data in order to accelerate the access rate of the storage device, thereby increasing data processing efficiency.

The object of the present invention is to provide a multi-channel memory storage device and a control method thereof, so that data can be arranged to be written in memories in such a way, as to accelerate the access rate of the storage device, and thereby increasing data process efficiency of the memory.

For achieving the object described above, the present invention disclosed a control method of a multi-channel memory storage device, data transmitted from a host is arranged in a storage device, and the storage device includes a plurality of memory units. The control method includes the steps: first, identify size of the data and compare the size of the data with a threshold value; then to decide arranging method of the data according to the comparing result, wherein if the data size is less than the threshold value, the data is arranged in one of the memory units; otherwise, the data is equally divided and arranged into the multi memory units synchronously.

A multi-channel memory storage device of the present invention is further disclosed, which access data transmitted from a host. The multi-channel memory storage device includes a nonvolatile memory unit, a data size identifying unit and a distributing unit. The nonvolatile memory unit includes a plurality of memory units; the data size identifying unit compares the size of the data with a threshold value; and the distributing unit is connected between the data size identifying unit and the nonvolatile memory unit to decide whether the data should be arranged in a single memory unit or multi memory units according to the comparing result.

The aforementioned brief description and the following detailed description aim to disclose the method, the instrument and the efficiency of the present invention. Other objects and advantageous of the present invention will be explained in the following description and drawings.

### BRIEF DESCRIPTION OF THE DRAWINGS

FIG. 1 is a system block diagram illustrating a multi-channel memory storage device of a prior art;

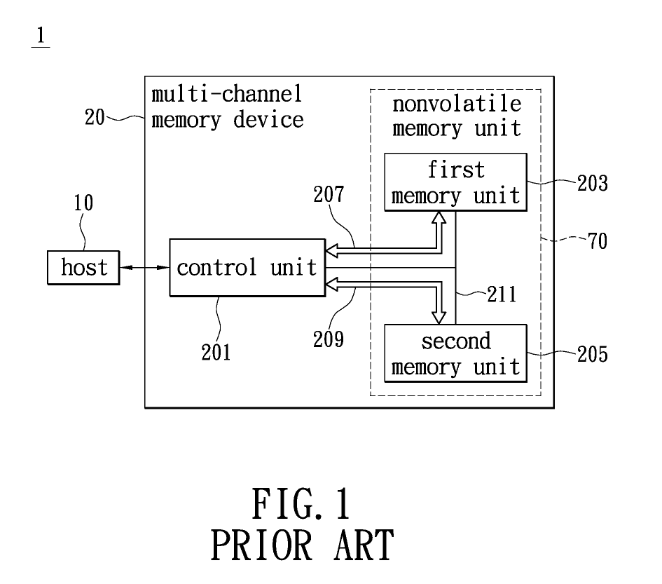

FIG. 2 is a action schematic view illustrating how data is written into a multi-channel memory storage device of a prior art;

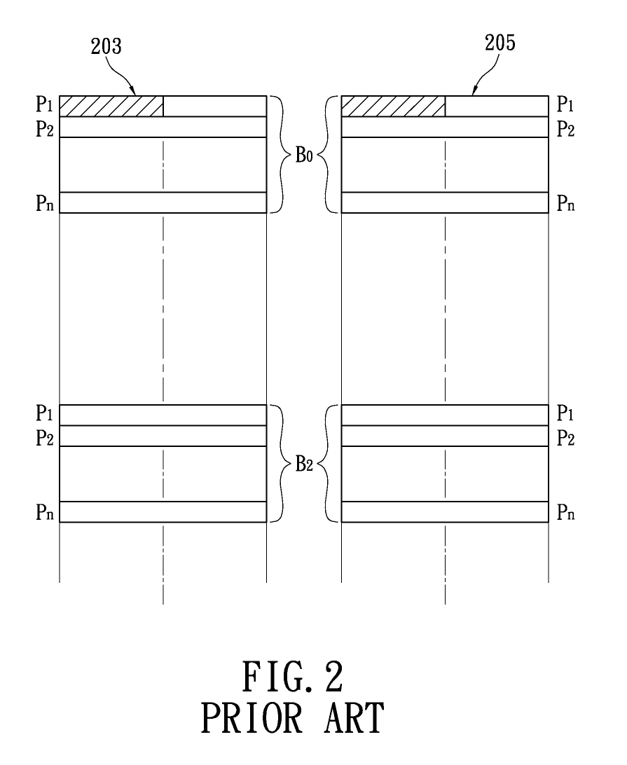

FIG. 3 is a system block diagram illustrating a multi-channel memory storage device of a first preferred embodiment according to the present invention;

FIG. 4 is a flow diagram illustrating a control method of a multi-channel memory storage device according to the present invention;

FIG. 5 is a system block diagram illustrating a multi-channel memory storage device of a second preferred embodiment according to the present invention; and

FIG. 6 is a system block diagram illustrating a multi-channel memory storage device of a third preferred embodiment according to the present invention.

### DETAILED DESCRIPTION OF THE PREFERRED EMBODIMENTS

For a multi-channel memory storage device, in regard to files with large size, it is timesaving to synchronously write the file's data via a plurality of parallel memories rather than via a single memory. Because a file with large size would take up a majority of a memory unit's block, the amount of redundant data being copied is small. On the other hand, if there is a file with small size which takes up a small portion of a memory unit's block, even though the data writing time would be somewhat longer, in the long run a single memory is better suited to access the data, because processing of redundant data is avoided. Generally, small and large data size can be defined in terms of a memory unit's block. When a data is a fraction of memory unit's block, generally less then a page, it is considered small; when a data takes up the size of a memory unit's block's page or more, it is considered large.

Thus, the multi-channel memory storage device and the control method of the present invention can identify the incoming data size transmitted from a host and adjust appropriately the transmitting mode (single channel or multi channel) to transmit the data according to the data size, and thereby increasing the accessing rate and the data processing efficiency of the storage device.

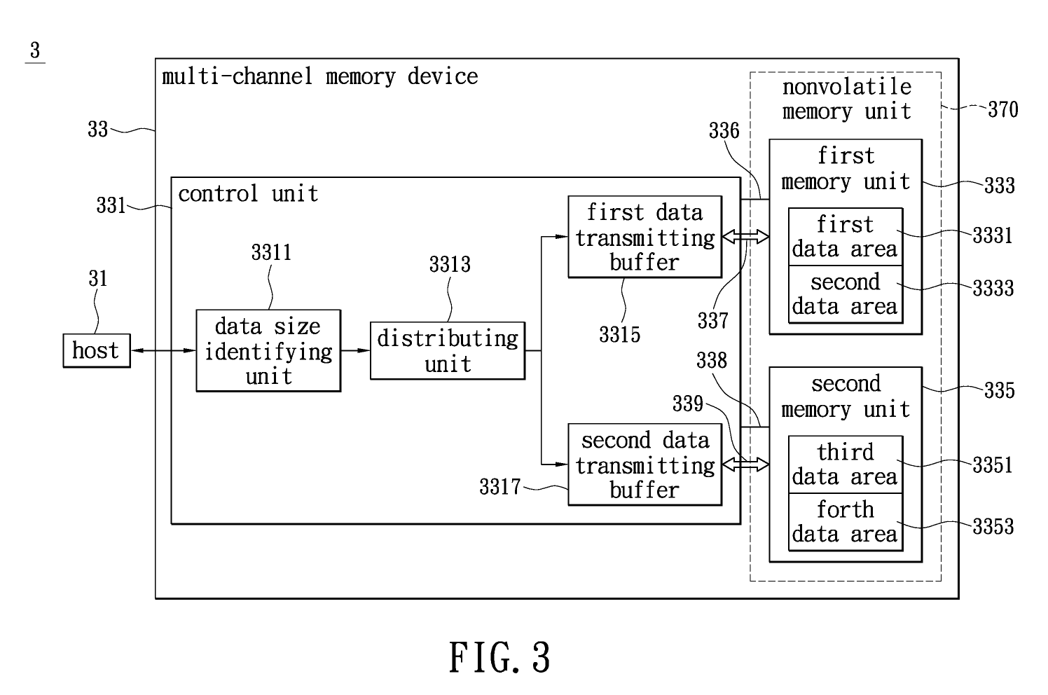

First, please refer to FIG. 3, which is a system block diagram illustrating a multi-channel memory storage device of a first preferred embodiment according to the present invention. A multi-channel memory storage device 33 (storage device 33 hereinafter) is used by a digital system 3 for data writing and reading. In the digital system 3, the storage device 33 is coupled to a host 31 to receive and execute instructions from the host 31. Physically, the host 31 may be a computer system, and the storage device 33 may be a hard disk of a computer system.

The storage device 33 includes a nonvolatile memory unit 370 and a control unit 331. The nonvolatile memory unit 370 includes a first memory unit 333 and a second memory unit 335, which may be single-level cell memories (SLC), phase changing memories (PCM), free Fe random-access memories (FeRAM), magnetic random-access memories (MRAM), or multi-level cell memories (MLC). The first memory unit 333 includes a first data area 3331 and a second data area 3333 and is coupled to the control unit 331 via an instruction transmitting wire 336 and via a data transmitting wire 337. The second memory unit 335 includes a third data area 3351 and a forth data area 3353 and is coupled to the control unit 331 via an instruction transmitting wire 338 and via a data transmitting wire 339. Wherein, the first data area 3331 and the third data area 3351 are used to store a data with small size, and the second data area 3333 and the forth data area 3353, in a parallel way, are used to store data with large size.

The control unit 331 is coupled between the host 31 and the nonvolatile memory unit 370. The control unit 331 receives instructions from the host 31, and the instruction may be a write instruction or a read instruction. Wherein, the written instruction would include a logic block address, and the data corresponding to that logic block address is written into the nonvolatile memory unit 370; similarly, the read instruction would include a logic block address, and the data corresponding to that logic block address is read from the nonvolatile memory unit 370. The control unit 331 includes a system interface (not shown), a data size identifying unit 3311, a distributing unit 3313, a first data transmitting buffer 3315, and a second data transmitting buffer 3317. The system interface is coupled to the host 31 to receive instructions from the host 31 and to transmit the data corresponding to the instructions, and the system interface acts as a transmitting interface between the host 31 and the storage device 33. The data size identifying unit 3311 is coupled to the host 31 to identify the size of the data correspond to the instruction. The distributing unit 3313 is coupled between the data size identifying unit 3311 and the nonvolatile memory unit 370 and distributes the data to an appropriate memory according to the size of the data. The first data transmitting buffer 3315 and the second data transmitting buffer 3317 are coupled to the distributing unit 3313 to provisionally store either the data transmitted from the host 31 to the storage device 33 or the data that is going to be read from the storage device 33 by the host 31.

In a preferred embodiment, the data corresponding to an instruction of the host 31 (data set hereinafter) is transmitted to the data size identifying unit 3311 to identify the size of the data. The distributing unit 3313 distributes the data set into both the first data transmitting buffer 3315 and the second data transmitting buffer 3317 or just one of them according to the size of the data set. Then, the first data transmitting buffer 3315 and the second data transmitting buffer 3317 respectively transmit the data set to the first memory unit 333 and the second memory unit 335 via the data transmitting wires 337, 339. The data size identifying unit 3311 assesses the size of the data against the smallest memory unit, which would be 1 page. If the size is less than or equal to 1 page, then the data set is defined as small capacity data, otherwise, it is defined as big capacity data.

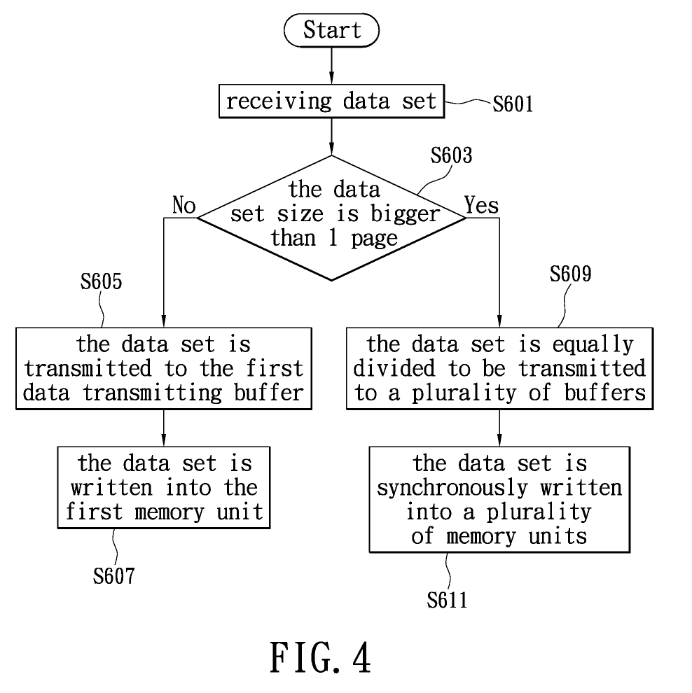

Next please refer to FIG. 4, which is a flow diagram illustrating a control method of a multi-channel memory storage device according to the present invention. Wherein, the physical component within FIG. 4 can be referenced by FIG. 3. As shown in FIG. 4, the control method steps include:

First, the data size identifying unit 3311 receives data set (step S601);

Second, the size of data set is identified by comparing the data set size to a threshold value (step S603). Wherein, the threshold value is defines as the smallest memory unit that can be written for the multi-channel memory storage device 33, which would be 1 page. If the data set size is larger than 1 page, the data set would be equally divided into two portions by the distributing unit 3313 and respectively transmitted to the first data transmitting buffer 3315 and the second data transmitting buffer 3317 for temporary storage (step S609). Wherein, the unit of the equally divided portions is in bits, that is, the data set is divided into an odd number of bits and an even number of bits; or in another embodiment, the unit may be in pages, that is, an odd number of pages and an even number of pages. Finally, the equally divided data set is then synchronously written into the second data area 3333 of the first memory unit 333 and the forth data area 3353 of the second memory unit 335 respectively from the first data transmitting buffer 3315 and the second data transmitting buffer 3317 (step S611).

However, if the data set size is less than or equal to 1 page, the data set is transmitted to the first data transmitting buffer 3315 (or the second data transmitting buffer 3317) by the distributing unit 3313 for temporary storage (step S605). Finally, the data set is then written into the first data area 3331 of the first memory unit 333 (or the second memory unit 335 of the third data area 3351) (step S607).

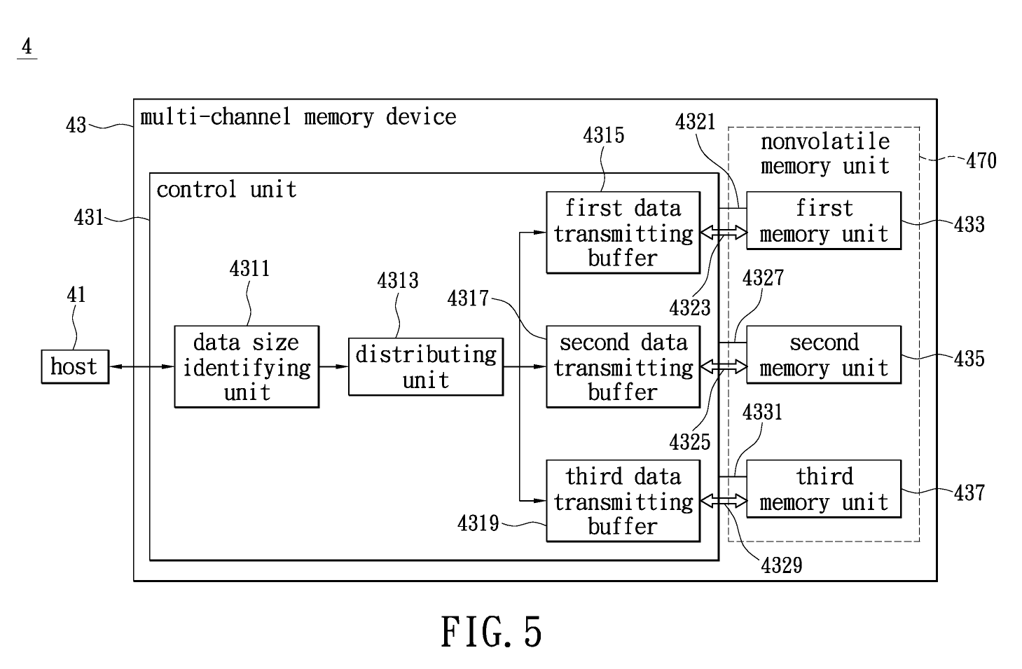

Please refer to FIG. 5, which is a system block diagram illustrating a multi-channel memory storage device of a second preferred embodiment according to the present invention. In FIG. 5, there are some modifications from FIG. 3, so please also refer to FIG. 3 and FIG. 4 for clarity.

Compared with the system block in FIG. 3, a nonvolatile memory unit 470 of a multi-channel memory device 43 of FIG. 5 includes a first memory unit 433, a second memory unit 435, and a third memory unit 437, which are connected with a control unit 431 via instruction transmitting wires 4321, 4327, 4331 and data transmitting wires 4323, 4325, 4329 respectively to appoint a data accessing address to transmit the data. Wherein, the third memory unit 437 is used to store data of small size. Because data of small size is frequently accessed, and in view of the accessing rate and erasing frequency, preferably, the third memory unit 437 should be a single-level cell memory (SLC), a phase changing memory (PCM), a free Fe random-access memory (FeRAM), or a magnetic random-access memory (MRAM). The first memory unit 433 and the second memory unit 435 is used to store a data of large size via a parallel method and should preferably be multi-level cell memories (MLC) of a high-density memory.

In a preferred embodiment, a host 41 transmits data set into a data size identifying unit 4311 (step S601) to identify the size of the data set via the data size identifying unit 4311 (step S603). If the size of the data set is larger than 1 page, the data set is equally divided into two portions by the distributing unit 4313 and respectively transmitted to the first data transmitting buffer 4315 and the second data transmitting buffer 4317 for temporary storage (step S609). Finally, the equally divided data set is then synchronously written into the first memory unit 433 and the second memory unit 435 from the first data transmitting buffer 4315 and the second data transmitting buffer 4317 respectively (step S611). However, if the data set size is less than or equal to 1 page, the data set is transmitted to the third data transmitting buffer 4319 by the distributing unit 4313 for temporary storage (step S605). Finally, the data set is then written into the third memory unit 437 (step S607).

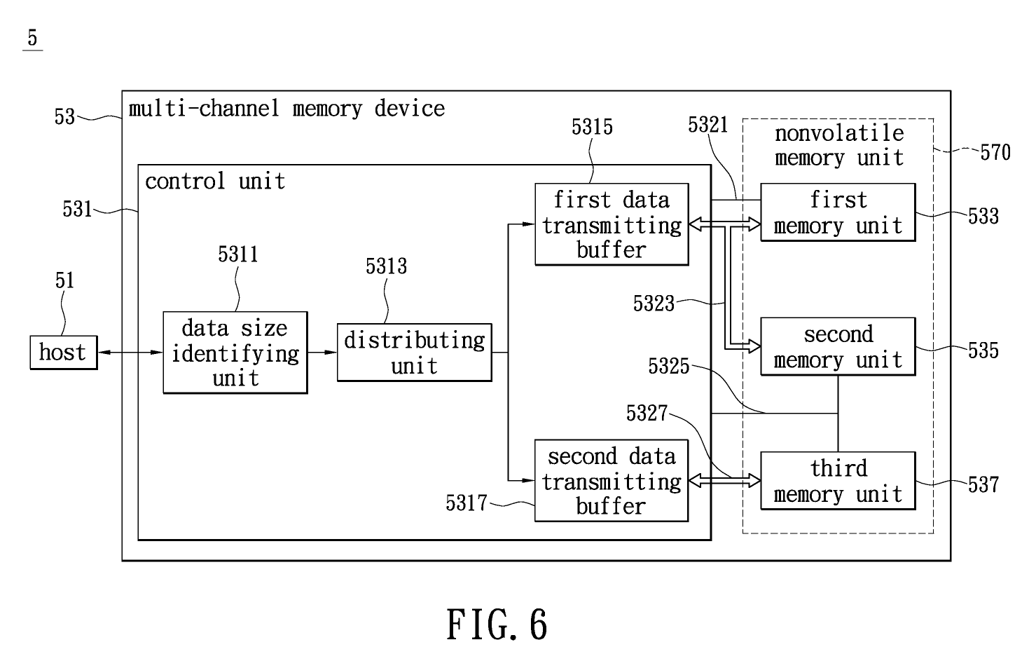

Please refer to FIG. 6, which is a system block diagram illustrating a multi-channel memory storage device of a third preferred embodiment according to the present invention. In FIG. 6, there are some modifications from FIG. 3, so please also refer to FIG. 3 and FIG. 4.

Compared with the system block in FIG. 3, a nonvolatile memory unit 570 of a multi-channel memory device 53 of FIG. 6 includes a first memory unit 533, a second memory unit 535 and a third memory unit 537, which are connected with a control unit 531 via instruction transmitting wires 5321, 5325 and data transmitting wires 5323, 5327 respectively to appoint a data accessing address to transmit the data. The first memory unit 533 and the second memory unit 535 transmit data via the common data transmitting wires 5323, and the second memory unit 535 and the third memory unit 537 receive instructions output from the control unit 531 via the common instruction transmitting wires 5325. Wherein, the first memory unit 533 is used to store a data of small size, preferably, the first memory unit 533 may be a single-level cell memory (SLC) of a low-density memory, a phase changing memory (PCM), a free Fe random-access memory (FeRAM), or a magnetic random-access memory (MRAM). The second memory unit 535 and the third memory unit 537 is used to store a data of large size via a parallel method and should preferably be multi-level cell memories (MLC) of a high-density memory.

In a preferred embodiment, a host 51 transmits the data set into a data size identifying unit 5311 (step S601) to identify the size of the data set via the data size identifying unit 5311 (step S603). If the data size is larger than 1 page, the data set is equally divided into two portions by the distributing unit 5313 and respectively transmitted to the first data transmitting buffer 5315 and the second data transmitting buffer 5317 for temporary storage (step S609). Finally, the equally divided data set is then synchronously written into the second memory unit 535 and the third memory unit 537 from the first data transmitting buffer 5315 and the second data transmitting buffer 5317 respectively via the data transmitting wires 5323, 5327 (step S611). However, if the data set size is less than or equal to 1 page, the data set is transmitted to first data transmitting buffer 5315 by the distributing unit 5313 for temporary storage (step S605). Finally, the data set is then written into the first memory unit 533 via the data transmitting wire 5323 (step S607).

In summary, the multi-channel memory storage device of each embodiment of the present invention doesn't limit the number of the parallel memories and the parallel method. In addition to the mentioned single channel and the dual channels (the two parallel memories) that can be thought of as channel mode, a combination of a single channel and a plurality of multi-channels can also be accepted. For example, a channel frame includes a single channel, dual channels, and four channels. Each channel frame may deal with its own appropriate data size, for example, the single channel may deal with 1 page data, the double channels may deal with the data of size between 1 page and 4 pages, and the four channels may deal data of size with more than 4 pages.

From the aforementioned embodiments, by means of identifying the data size, the present invention can write data of small size in a single memory (small data storage unit) and write a data of large size to parallel memories via the transmission of the multi-channel (large data storage unit), thereby adjusting channel mode, all in order to transmit the data to accelerate the access rate of the storage device. At the same time, redundant data removing and block erasing is avoided, and the data processing efficiency is increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-channel memory storage device, used by a host to access a data set, the storage device comprising:
a plurality of memory units; and
a control unit, coupled between said host and said memory units and arranging said data set in a single memory unit or multi memory units according to the size of said data set.

2. The multi-channel memory storage device according to claim 1, wherein said control unit comprises:
a data size identifying unit coupled to said host and is used to comparing the size of said data set to a threshold value; and
a distributing unit coupled between said data size identifying unit and said memory units and deciding whether the data set is transmitted to a single memory unit or multi memory units according to the comparison result of said data size identifying unit.

3. The multi-channel memory storage device according to claim 2, wherein said control unit further comprises:
a plurality of data transmitting buffers connected with said distributing unit and temporarily storing said data set.

4. The multi-channel memory storage device according to claim 2, wherein said threshold value is of the smallest memory unit that can be written for the said multi-channel memory storage device.

5. The multi-channel memory storage device according to claim 2, wherein said data set is transmitted to one of said memory units by said distributing unit, if the size of the data set is less than or equal to said threshold value.

6. The multi-channel memory storage device according to claim 2, wherein said distributing unit equally divides said data set and synchronously transmits the divided data to said multi memory units, if the size of the data set is larger than said threshold value.

7. The multi-channel memory storage device according to claim 3, wherein said multi memory units include a small data storage unit and a large data storage unit, and the storage space of said small data storage unit is less than that of said large data storage unit.

8. The multi-channel memory storage device according to claim 1, wherein said multi memory units may be single-level cell memories (SLC), phase changing memories (PCM), free Fe random-access memories (FeRAM), magnetic random-access memories (MRAM), or multi-level cell memories (MLC).

9. The multi-channel memory storage device according to claim 7, wherein said plurality of data transmitting buffers comprises a first data transmitting buffer and a second data transmitting buffer, said memory units comprise a first memory unit and a second memory unit, and said first memory unit comprises a first data area and a second data area, and said second memory unit comprises a third data area and a forth data area, said first data area and said third data area are small data storage units, said second data area and said forth data area are large data storage units, and said first data transmitting buffer and said second data transmitting buffer are respectively coupled to said first memory unit and said second memory unit.

10. The multi-channel memory storage device according to claim 3, wherein said plurality of data transmitting buffers comprises a first data transmitting buffer, a second data transmitting buffer and a third data transmitting buffer, said memory units comprise a first memory unit, a second memory unit and a third memory unit, and said first data transmitting buffer, said second data transmitting buffer and said third data transmitting buffer are respectively coupled to said first memory unit, said second memory unit and said third memory unit.

11. The multi-channel memory storage device according to claim 3, wherein said plurality of data transmitting buffers comprises a first data transmitting buffer and a second data transmitting buffer, and said memory units comprise a first memory unit, a second memory unit and a third memory unit, and said first data transmitting buffer is coupled to said first memory unit and said second memory unit, and said second data transmitting buffer is coupled to said third memory unit.

12. A control method of a storage device, arranging a data set in a multi-channel memory storage device, wherein said multi-channel memory storage device comprises a plurality of memory units, said control method comprising the steps:
identifying the size of the data set, comparing the size of the data set with a threshold value; and
arranging said data set in one or several memory units of said plurality of memory units according to the comparing result.

13. The control method according to claim 12, wherein said data set is transmitted to one of said memory units if said size of the data set is less than or equal to said threshold value; otherwise, said data set is distributed and transmitted to several memory units.

14. The control method according to claim 12, wherein each memory unit comprises a small data storage unit and a large data storage unit.

15. The control method according to claim 14, wherein said data set is transmitted to the small data storage unit of one of said memory units if said size of the data set is smaller than said threshold value, otherwise, said data set is equally divided and synchronously transmitted to the large data storage unit of each memory unit.
